(19) United States
(12) Patent Application Publication
(10) Pub. No.: US 2016/0334609 A1
(43) Pub. Date: Nov. 17, 2016

(54) ZOOM LENS

(71) Applicant: CALIN TECHNOLOGY CO., LTD., Taichung City (TW)

(72) Inventors: MING-LIN LEE, Taoyuan City (TW); CHIEN-HSIUNG TSENG, Hsinchu City (TW)

(21) Appl. No.: 14/713,342

(22) Filed: May 15, 2015

(51) Int. Cl. G02B 15/177; G02B 13/00

(52) U.S. Cl. CPC G02B 15/177; G02B 13/0045; G02B 13/008; G02B 13/009

(57) ABSTRACT

A zoom lens includes, in order from an object side to an image side, a first lens group, an aperture, and a second lens group. The first lens group has negative refractive power, and is composed of a negative first lens, a negative second lens, and a positive third lens. The third lens and the second lens are adhered together to form a negative doublet. The second lens group has positive refractive power, and is composed of a positive fourth lens, a negative fifth lens, a positive sixth lens, a positive seventh lens, a negative eighth lens, and a positive ninth lens. The sixth lens and the fifth lens are adhered together to form a negative doublet. In addition, the first lens group can be moved between the object side and the aperture, while the second lens group can be moved between the aperture and the image side.

### BACKGROUND OF THE INVENTION

1. Technical Field

The present invention relates generally to optical lens, and more particularly to a zoom lens.

2. Description of Related Art

With the recent advancement in semiconductor technology, optical devices such as surveillance cameras are possible to provide images of higher quality, and hence the lenses used in such devices are required to provide higher resolution for the increasing demand in image sensors including more pixels. More specifically, it would be preferable to have a lens which has a wide viewing angle at a short focus end. In addition, lower manufacturing cost and more compact size are always welcomed by manufactures and end-users too.

When in the daytime, the lens of the aforementioned optical devices uses visible light to capture images; when in night, near infrared light is used instead. In order to ensure that captured images have sufficient brightness even in a dim environment, the aforementioned optical devices are typically provided with a large-aperture lens, which has two lens groups respectively installed at two opposite sides of an aperture. Some examples of this kind of lens are disclosed in U.S. Pat. No. 8,395,847, U.S. Pat. No. 8,184,379, U.S. Pat. No. 8,085,474, and U.S. Pat. No. 7,652,827, which is able to provide a zooming function, and also to meet the aforementioned optical requirements.

The image format of the image sensors used in the disclosures of the U.S. patents listed above are all between ⅓ to 1/2.7 inches. However, an image sensor would need a larger image format when pixels are increase to exceed 5 million, for smaller single pixel size causes poor sensitivity. The problem is, with an image sensor which has a larger image format, not only the size of lens becomes larger, but also the manufacturing cost rises. Such condition does not correspond to the demands of the market.

It can be seen from the above description that the design of conventional zoom lenses is not perfect, for it is insufficient to satisfy the market of high-end applications which demands high resolution. Therefore, there is still room for improvement for zoom lenses.

### BRIEF SUMMARY OF THE INVENTION

In view of the above, the primary objective of the present invention is to provide a zoom lens, which has the characteristic of a large aperture from a wide-angle end to a telephoto end thereof, and can be compatible with a large optical image sensor of, for example, ½ inches. In addition, the size of the zoom lens can be still compact, and the total length is comparable to that of a conventional lens. Furthermore, the zoom lens provided in the present invention can correct aberration from visible light to infrared light, provide high resolution and the effect of large aperture, and has the advantage of ease of manufacture and assembly.

The present invention provides a zoom lens, which includes, in order from an object side to an image side along an optical axis, a first lens group, an aperture, and a second lens group. The first lens group has negative refractive power, and is composed of a first lens, a second lens, and a third lens arranged sequentially from the object side to the image side, wherein the first lens has negative refractive power; the second lens has negative refractive power; the third lens has positive refractive power, and is adhered to the second lens to form a negative doublet; in addition, the first lens, the second lens, and the third lens are synchronously movable along the optical axis between the object side and the aperture. The second lens group has positive refractive power, and is composed of a fourth lens, a fifth lens, a sixth lens, a seventh lens, an eighth lens, and a ninth lens arranged sequentially from the object side to the image side; the fourth lens has positive refractive power; the fifth lens has negative refractive power; the sixth lens has positive refractive power, and is adhered to the fifth lens to form a negative doublet; the seventh lens has positive refractive power; the eighth lens has negative refractive power; the ninth lens has positive refractive power; in addition, the fourth lens, the fifth lens, the sixth lens, the seventh lens, the eighth lens, and the ninth lens are synchronously movable along the optical axis between the aperture and the image side.

With the aforementioned design, the size of the zoom lens can be still compact, while the total lens can be comparable to that of a conventional zoom lens. Furthermore, the zoom lens provided in the present invention is compatible with a large image sensor of, for example, ½ inches. In addition, the aberration from visible light to infrared light can be corrected by the zoom lens, which also provides high resolution and the effect of large aperture, and has the advantage of ease of manufacture and assembly.

### BRIEF DESCRIPTION OF THE SEVERAL VIEWS OF THE DRAWINGS

The present invention will be best understood by referring to the following detailed description of some illustrative embodiments in conjunction with the accompanying drawings, in which:

FIG. 1A is a schematic diagram of a first preferred embodiment of the present invention at the wide-angle end;

FIG. 1B is a schematic diagram of the first preferred embodiment of the present invention at the telephoto end;

FIG. 2A is a diagram showing the distortion of the first preferred embodiment of the present invention at the wide-angle end;

FIG. 2B is a diagram showing the field curvature of the first preferred embodiment of the present invention at the wide-angle end;

FIG. 2C is a diagram showing the longitudinal spherical aberration of the first preferred embodiment of the present invention at the wide-angle end;

FIG. 2D is a diagram showing the distortion of the first preferred embodiment of the present invention at the telephoto end;

FIG. 2E is a diagram showing the field curvature of the first preferred embodiment of the present invention at the telephoto end;

FIG. 2F is a diagram showing the longitudinal spherical aberration of the first preferred embodiment of the present invention at the telephoto end;

FIG. 3A is a schematic diagram of a second preferred embodiment of the present invention at the wide-angle end;

FIG. 3B is a schematic diagram of the second preferred embodiment of the present invention at the telephoto end;

FIG. 4A is a diagram showing the distortion of the second preferred embodiment of the present invention at the wide-angle end;

FIG. 4B is a diagram showing the field curvature of the second preferred embodiment of the present invention at the wide-angle end;

FIG. 4C is a diagram showing the longitudinal spherical aberration of the second preferred embodiment of the present invention at the wide-angle end;

FIG. 4D is a diagram showing the distortion of the second preferred embodiment of the present invention at the telephoto end;

FIG. 4E is a diagram showing the field curvature of the second preferred embodiment of the present invention at the telephoto end;

FIG. 4F is a diagram showing the longitudinal spherical aberration of the second preferred embodiment of the present invention at the telephoto end;

FIG. 5A is a schematic diagram of a third preferred embodiment of the present invention at the wide-angle end;

FIG. 5B is a schematic diagram of the third preferred embodiment of the present invention at the telephoto end;

FIG. 6A is a diagram showing the distortion of the third preferred embodiment of the present invention at the wide-angle end;

FIG. 6B is a diagram showing the field curvature of the third preferred embodiment of the present invention at the wide-angle end;

FIG. 6C is a diagram showing the longitudinal spherical aberration of the third preferred embodiment of the present invention at the wide-angle end;

FIG. 6D is a diagram showing the distortion of the third preferred embodiment of the present invention at the telephoto end;

FIG. 6E is a diagram showing the field curvature of the third preferred embodiment of the present invention at the telephoto end;

FIG. 6F is a diagram showing the longitudinal spherical aberration of the third preferred embodiment of the present invention at the telephoto end;

FIG. 7A is a schematic diagram of a fourth preferred embodiment of the present invention at the wide-angle end;

FIG. 7B is a schematic diagram of the fourth preferred embodiment of the present invention at the telephoto end;

FIG. 8A is a diagram showing the distortion of the fourth preferred embodiment of the present invention at the wide-angle end;

FIG. 8B is a diagram showing the field curvature of the fourth preferred embodiment of the present invention at the wide-angle end;

FIG. 8C is a diagram showing the longitudinal spherical aberration of the fourth preferred embodiment of the present invention at the wide-angle end;

FIG. 8D is a diagram showing the distortion of the fourth preferred embodiment of the present invention at the telephoto end;

FIG. 8E is a diagram showing the field curvature of the fourth preferred embodiment of the present invention at the telephoto end;

FIG. 8F is a diagram showing the longitudinal spherical aberration of the fourth preferred embodiment of the present invention at the telephoto end;

FIG. 9A is a schematic diagram of a fifth preferred embodiment of the present invention at the wide-angle end;

FIG. 9B is a schematic diagram of the fifth preferred embodiment of the present invention at the telephoto end;

FIG. 10A is a diagram showing the distortion of the fifth preferred embodiment of the present invention at the wide-angle end;

FIG. 10B is a diagram showing the field curvature of the fifth preferred embodiment of the present invention at the wide-angle end;

FIG. 10C is a diagram showing the longitudinal spherical aberration of the fifth preferred embodiment of the present invention at the wide-angle end;

FIG. 10D is a diagram showing the distortion of the fifth preferred embodiment of the present invention at the telephoto end;

FIG. 10E is a diagram showing the field curvature of the fifth preferred embodiment of the present invention at the telephoto end; and

FIG. 10F is a diagram showing the longitudinal spherical aberration of the fifth preferred embodiment of the present invention at the telephoto end.

It should be noted that the diagrams showing the distortion, the field curvature, and the longitudinal spherical aberration of each embodiments at the wide-angle end and the telephoto end are optical simulation diagrams, which are obtained with light of 587 nm wavelength.

### DETAILED DESCRIPTION OF THE INVENTION

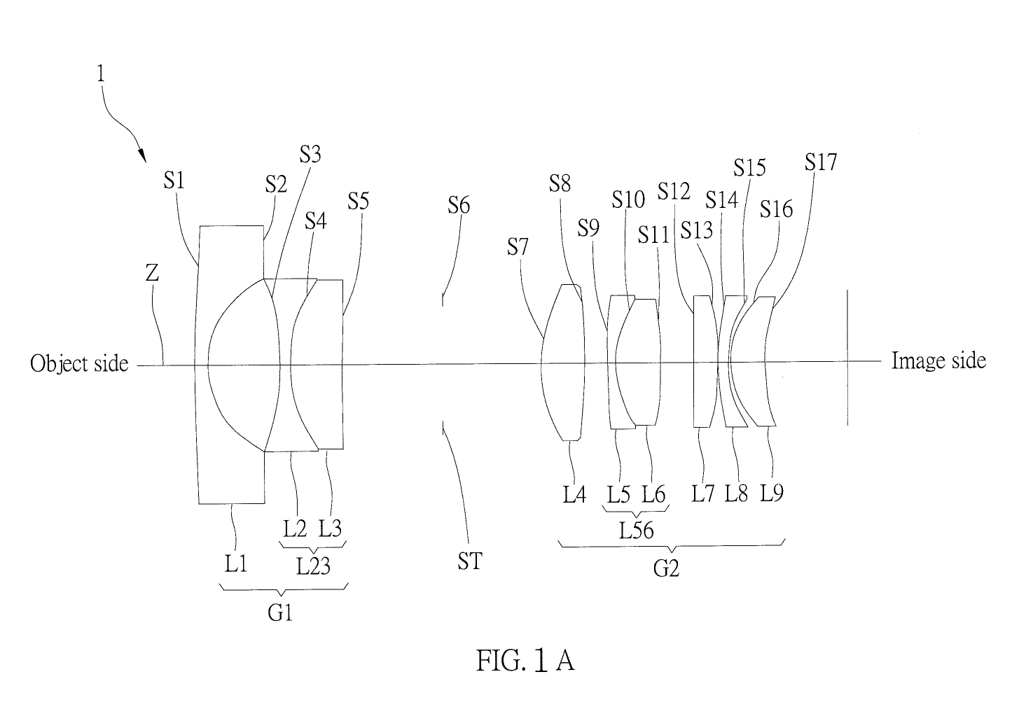

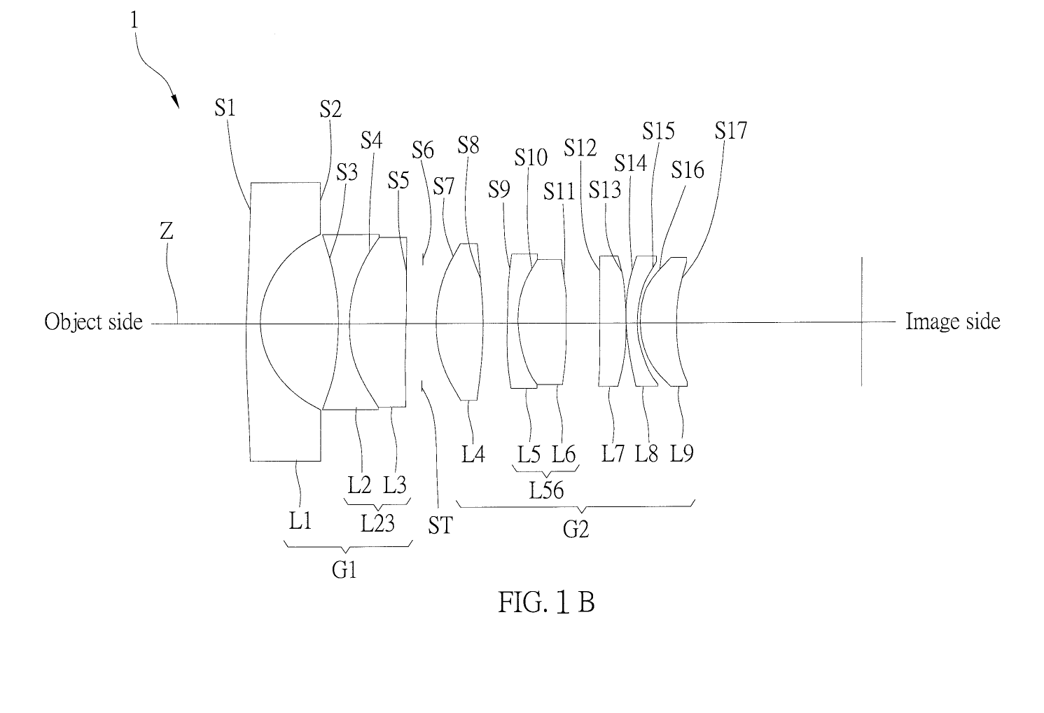

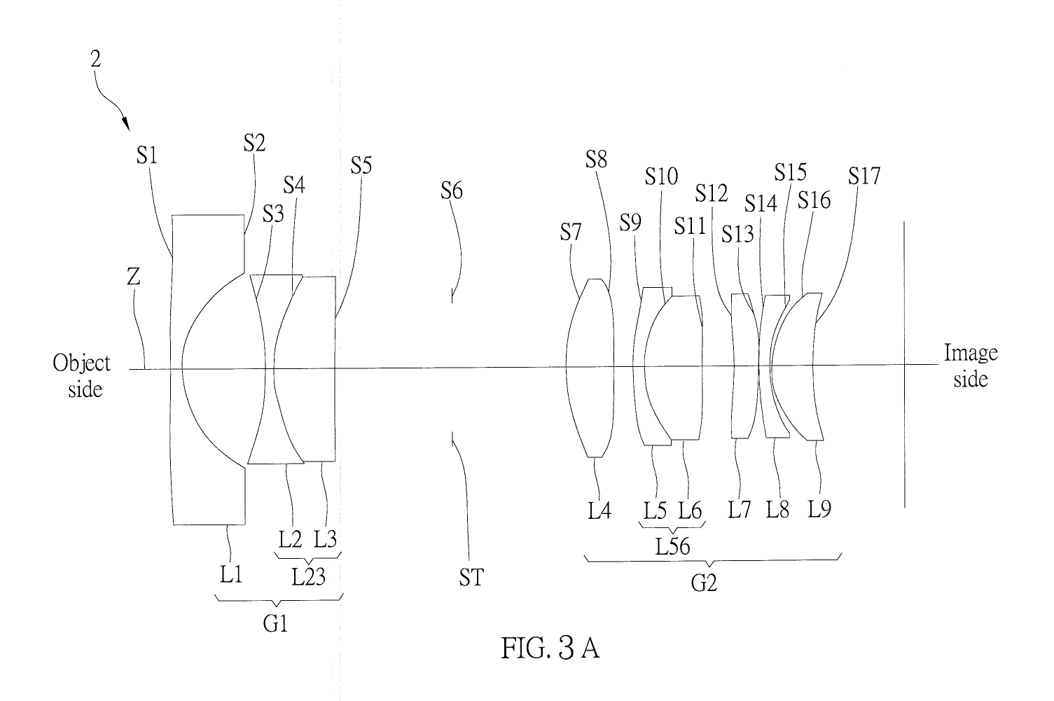

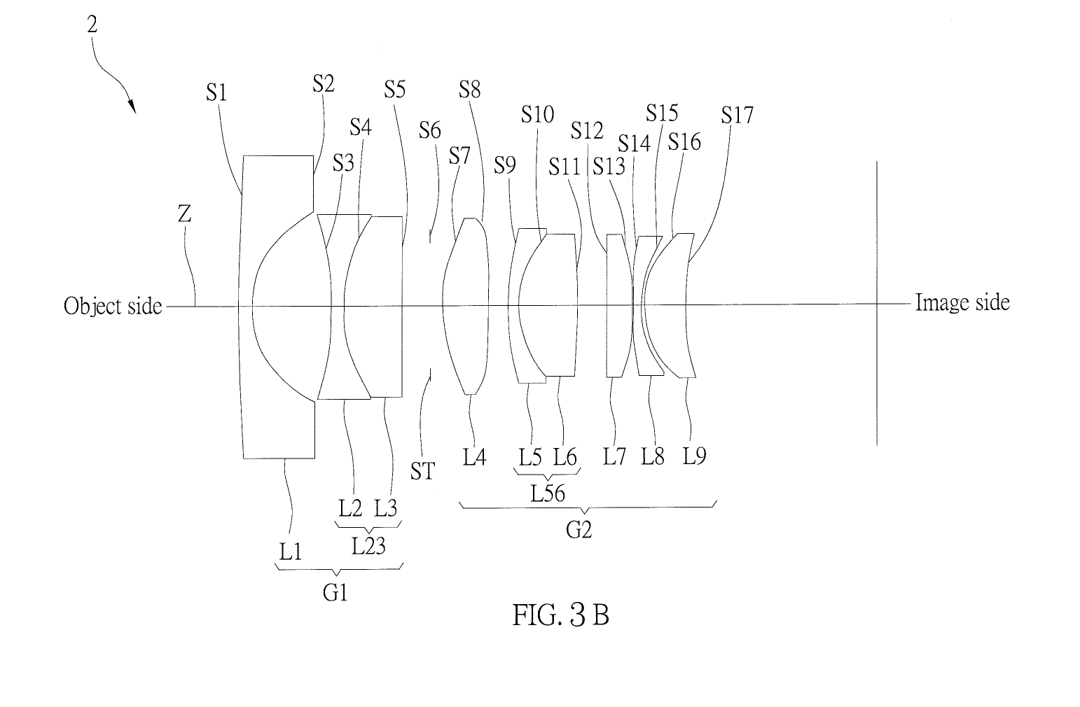

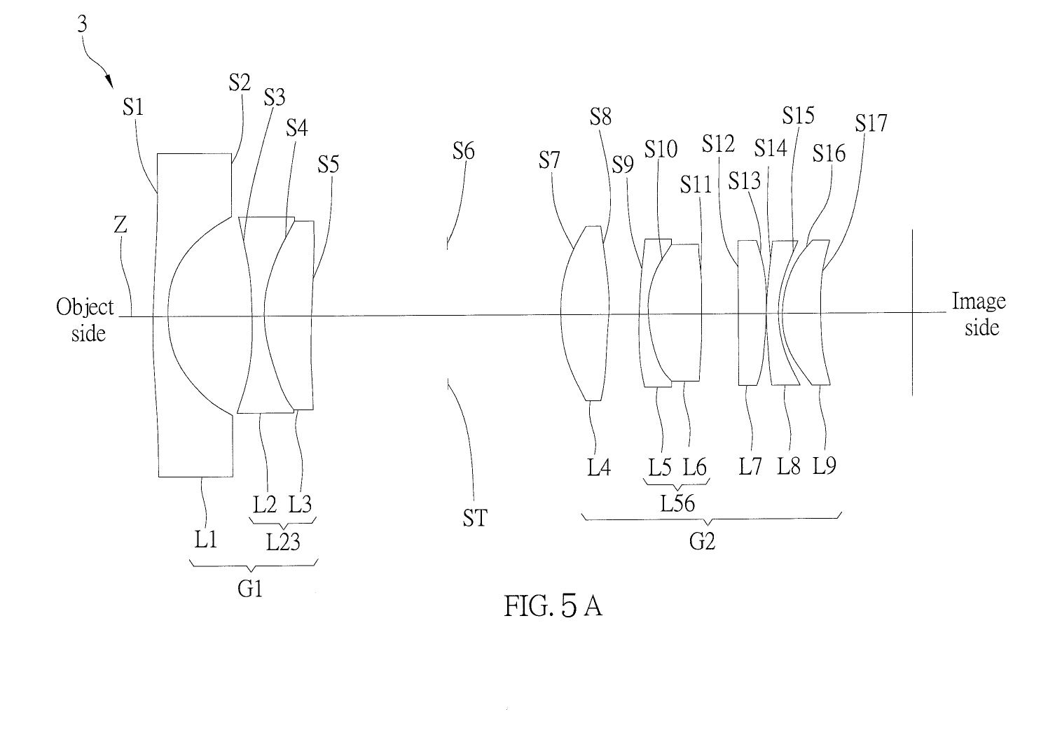

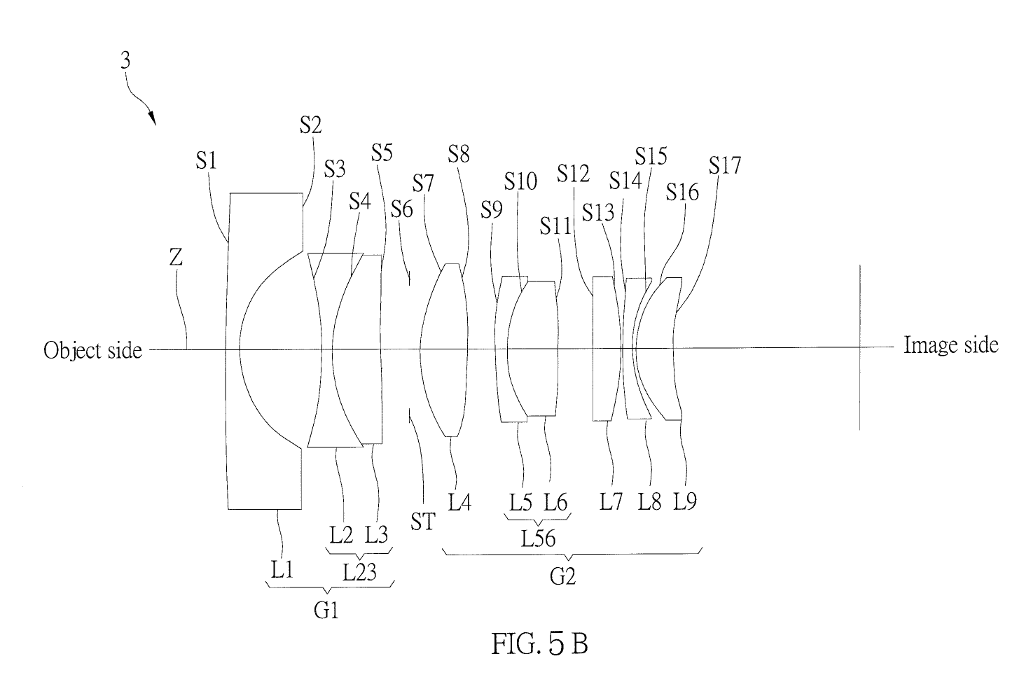

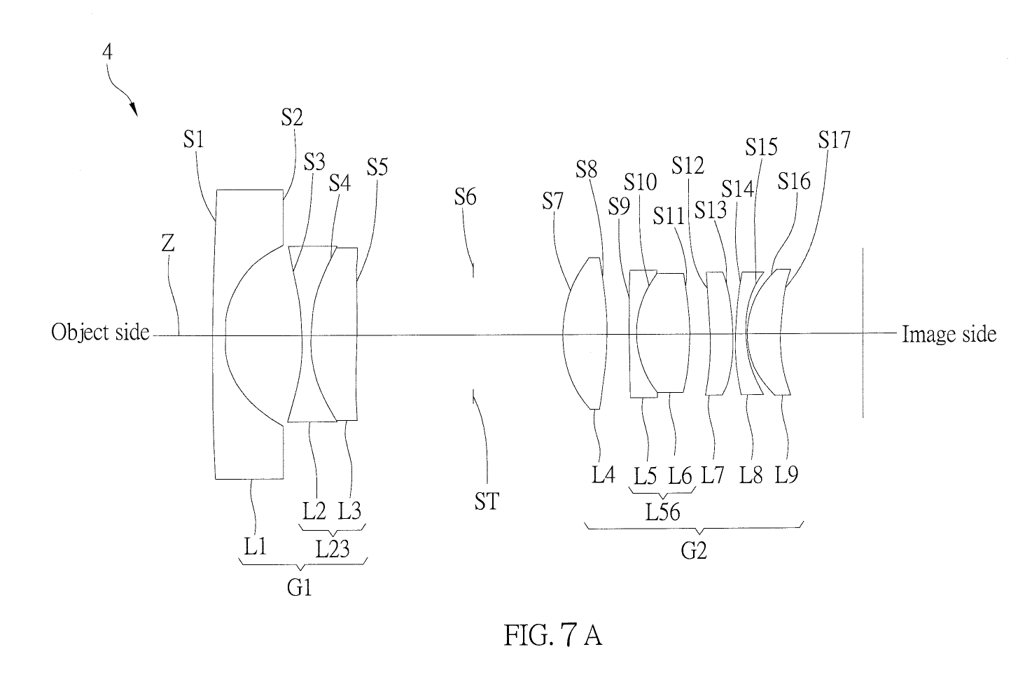

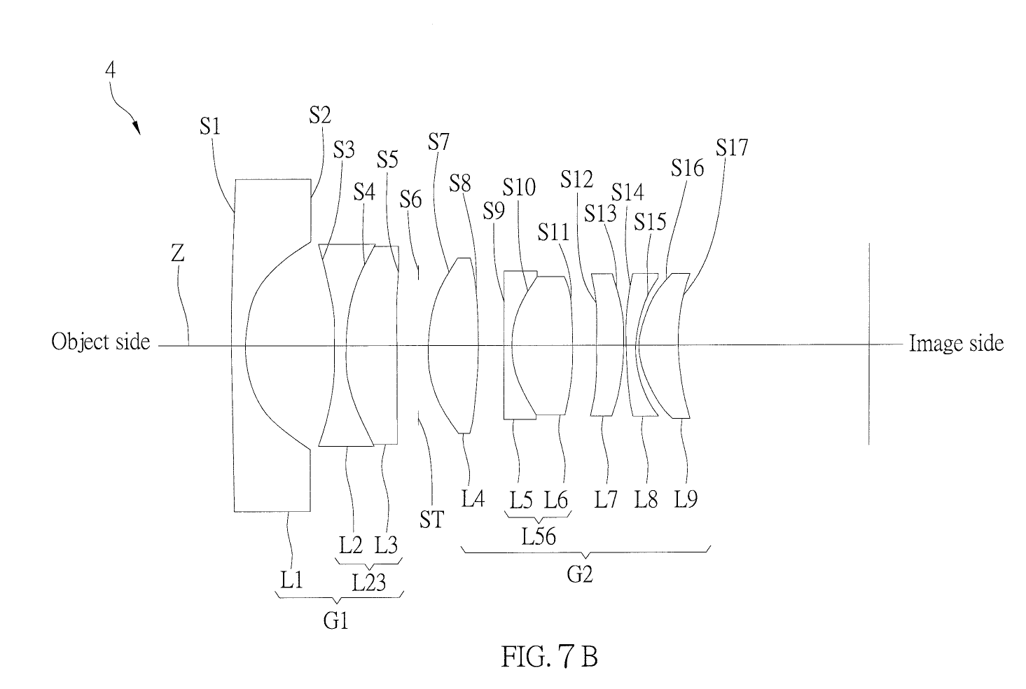

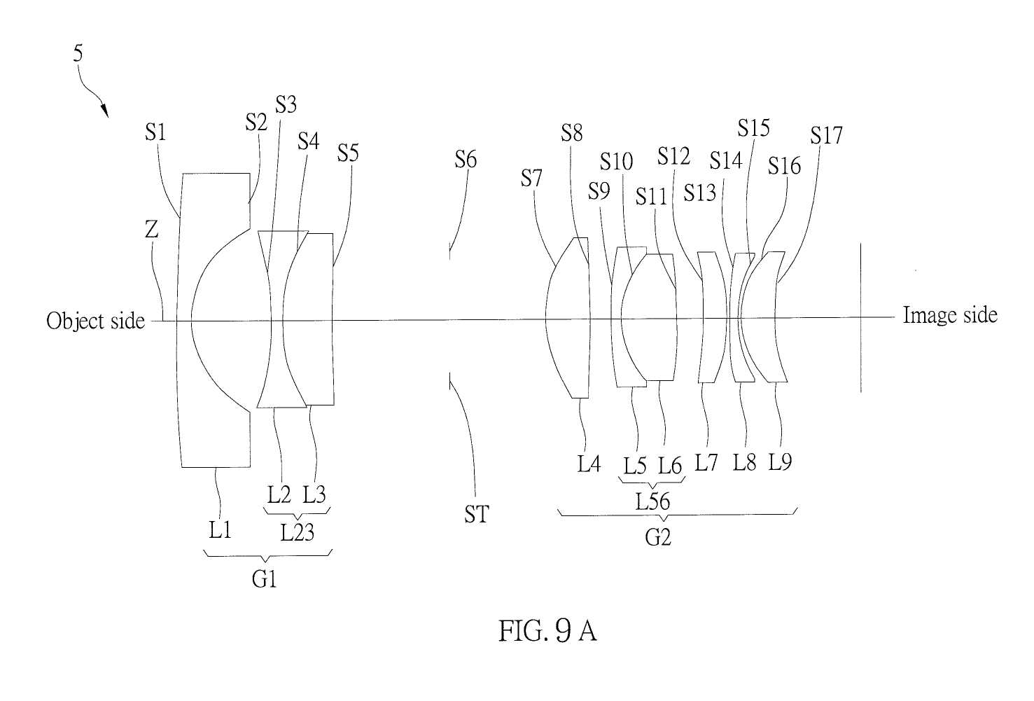

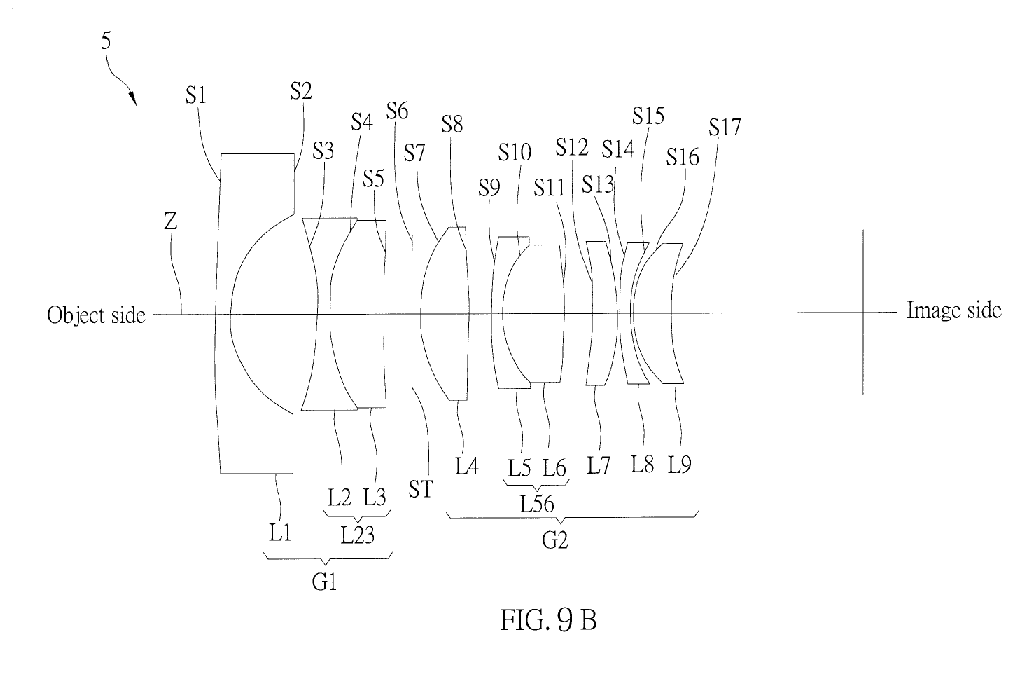

Zoom lenses 1-5 of the first to the fifth preferred embodiments of the present invention at a wide-angle end and at a telephoto end thereof are respectively shown in FIGS. 1A and 1B, FIGS. 3A and 3B, FIGS. 5A and 5B, FIGS. 7A and 7B, and FIGS. 9A and 9B.

Each of the zoom lenses 1-5 includes, in order from an object side to an image side along an optical axis Z, a first lens group G1, an aperture ST, and a second lens group G2. In addition, according to different requirements, the zoom lenses 1-5 can further include an optical filter provided at the aperture or between the second lens group G2 and the image side to filter out unwanted optical noise to enhance the optical performance Of course, the position of the optical filter can be changed to meet different design requirements, and is not limited by the above description.

The first lens group G1 has negative refractive power, and is composed of a first lens L1, a second lens L2, and a third lens L3 which are arranged sequentially from the object side to the image side, wherein the first lens L1, the second lens L2, and the third lens

L3 of the first lens group G1 can be moved synchronously along the optical axis Z between the object side and the aperture ST.

In more details, the first lens L1 is a meniscus lens which has negative refractive power, wherein a convex surface S1 thereof faces the object side, while a concave surface S2 thereof faces the image side.

The second lens L2 is a biconcave lens having negative refractive power.

The third lens L3 is a meniscus lens having positive refractive power, wherein a convex surface S4 thereof faces the object side, and is adhered to a concave surface of the second lens L2 which faces the image side to form a negative doublet L23. It is worth mentioning that, by adhering the negative second lens L2 and the positive third lens L3 together, and arranging the formed doublet L23 behind the first lens L1, the axial chromatic aberration caused by the first lens group G1 can be corrected.

The second lens group G2 has positive refractive power, and is composed of a fourth lens L4, a fifth lens L5, a sixth lens L6, a seventh lens L7, an eighth lens L8, and a ninth lens L9 which are arranged sequentially from the object side to the image side, wherein the fourth lens L4, the fifth lens L5, the sixth lens L6, the seventh lens L7, the eighth lens L8, and the ninth lens L9 of the second lens group G2 can be moved synchronously along the optical axis Z between the aperture ST and the image side. In this way, the imaging magnification of each of the zoom lenses 1-5 can be changed from a wide-angle end to a telephoto end.

In addition, while the imaging magnification of the zoom lenses 1-5 are being changed by moving the second lens group G2 along the optical axis Z between the image side and the aperture ST, the image plane of the zoom lenses 1-5 is being shifted consequently, which can be corrected by moving the first lens group G1.

In more details, the fourth lens L4 is a biconvex lens having positive refractive power, wherein two surfaces S7, S8 thereof are both aspheric.

The fifth lens L5 is a meniscus lens having negative refractive power, wherein a convex surface S9 thereof faces the object side, while a concave surface S10 thereof faces the image side.

The sixth lens L6 is a biconvex lens having positive refractive power, wherein a convex surface S10 thereof which faces the object side is adhered to the concave surface S10 of the fifth lens L5 to form a negative doublet L56. The purpose of providing the doublet L56 herein is to suppress the axial chromatic aberration caused by the second lens group G2 with the optical effect provided by the structure of the doublet L56.

The seventh lens L7 is a meniscus lens having positive refractive power, wherein a convex surface S13 thereof faces the image side, while a concave surface S12 thereof faces the object side. It is worth mentioning that, the purpose of having the positive sixth lens L6 followed by the seventh lens L7 which also has positive refractive power is in order to effectively share a diopter contributed by the sixth lens L6 in the optical system. Such design is not only able to further suppress the aberration, but also able to prevent the sixth lens L6 from over bending caused by excessive refractive power, which effectively eases the difficulty of manufacturing the sixth lens L6, and improves the error tolerance during assembling the zoom lenses 1-5.

The eighth lens L8 is a meniscus lens having negative refractive power, wherein a convex surface S14 thereof faces the object side, while a concave surface S15 thereof faces the image side.

The ninth lens L9 is a meniscus lens having positive refractive power, wherein a convex surface S16 thereof faces the object side, while a concave surface S17 thereof faces the image side. The surfaces S16, S17 are both aspheric.

Parameters of the zoom lenses 1-5 of the first to the fifth preferred embodiments are listed in the following Tables 1-5, respectively, including a radius of curvature R of each of surfaces S1-S17 at where the optical axis Z passes through, a distance D between two adjacent surfaces from S1 to S17 (or the imaging plane) along the optical axis Z, a refractive index Nd of each of lenses L1-L9, an Abbe number Vd of each of lenses L1-L9, and an effective focal length F, F numbers (Fno), and field of view (FOV(2ω)) of each of zoom lenses 1-5 at the wide-angle end and the telephoto end. With these parameters listed in Tables 1-5, the zoom lenses 1-5 of the first to the fifth preferred embodiments can effectively enhance optical performance

TABLE 1

| Surface | R (mm) | D (mm) | Nd | Vd | Component |
|---|---|---|---|---|---|
| S1 | 174.056 | 0.8845 | 1.691002 | 52.64 | first lens L1 |
| S2 | 6.738 | 5.1227 | | | |
| S3 | −18.978 | 0.8023 | 1.647689 | 33.79 | second lens L2 |
| S4 | 10.369 | 3.6618 | 1.922860 | 20.87 | third lens L3 |
| S5 | 178.656 | D5 | | | |
| S6 | ∞ | D6 | | | aperture ST |
| S7 | 10.245 | 3.1015 | 1.669547 | 55.42 | fourth lens L4 |
| S8 | −31.395 | 1.6063 | | | |
| S9 | 47.983 | 0.6960 | 1.808095 | 22.76 | fifth lens L5 |
| S10 | 8.084 | 3.1852 | 1.496999 | 81.54 | sixth lens L6 |
| S11 | −29.807 | 2.3654 | | | |
| S12 | −313.976 | 1.7094 | 1.922860 | 18.89 | seventh lens L7 |
| S13 | −20.515 | 0.0862 | | | |
| S14 | 18.991 | 0.6792 | 1.903664 | 31.31 | eighth lens L8 |
| S15 | 7.975 | 0.1736 | | | |
| S16 | 5.900 | 2.4141 | 1.496999 | 81.54 | ninth lens L9 |
| S17 | 15.802 | D17 | | | |

| | F | Fno | FOV(2ω) | D5 | D6 | D17 |
|---|---|---|---|---|---|---|
| wide- | 4.1 | 1.3 | 165.3 | 7.2914 | 7.0460 | 5.9312 |
| angle end | | | | | | |
| telephoto | 9.2 | 2.2 | 52.6 | 1.3209 | 0.7074 | 12.2699 |
| end | | | | | | |

TABLE 2

| Surface | R (mm) | D (mm) | Nd | Vd | Component |
|---|---|---|---|---|---|
| S1 | 190.711 | 0.8692 | 1.6779 | 55.34 | first lens L1 |
| S2 | 6.621 | 5.1254 | | | |
| S3 | −18.127 | 0.7 | 1.647689 | 33.79 | second lens L2 |
| S4 | 10.222 | 3.7340 | 1.92286 | 20.87 | third lens L3 |
| S5 | 149.207 | D5 | | | |
| S6 | ∞ | D6 | | | aperture ST |
| S7 | 10.348 | 3.0256 | 1.669547 | 55.42 | fourth lens L4 |
| S8 | −34.389 | 1.2953 | | | |
| S9 | 21.385 | 0.64 | 1.84666 | 23.77 | fifth lens L5 |
| S10 | 6.769 | 3.7369 | 1.496999 | 81.54 | sixth lens L6 |
| S11 | −44.344 | 1.8838 | | | |
| S12 | −184.845 | 1.6501 | 1.92286 | 18.89 | seventh lens L7 |
| S13 | −17.322 | 0.04 | | | |
| S14 | 24.811 | 0.6399 | 1.903664 | 31.31 | eighth lens L8 |
| S15 | 7.587 | 0.14 | | | |
| S16 | 5.605 | 2.6027 | 1.496999 | 81.54 | ninth lens L9 |
| S17 | 17.235 | D17 | | | |

| | F | Fno | FOV(2ω) | D5 | D6 | D17 |
|---|---|---|---|---|---|---|
| wide- | 4 | 1.3 | 167.8 | 7.5220 | 7.2870 | 5.8476 |
| angle end | | | | | | |
| telephoto | 9 | 2.3 | 55.4 | 1.8618 | 0.7982 | 12.3363 |
| end | | | | | | |

TABLE 3

| Surface | R (mm) | D (mm) | Nd | Vd | Component |
|---|---|---|---|---|---|
| S1 | 178.814 | 0.9620 | 1.6779 | 55.34 | first lens L1 |
| S2 | 6.863 | 5.3147 | | | |
| S3 | −19.561 | 0.7600 | 1.647689 | 33.79 | second lens L2 |
| S4 | 10.570 | 2.9703 | 1.92286 | 20.88 | third lens L3 |
| S5 | 132.523 | d5 | | | |
| S6 | infinity | d6 | | | aperture ST |
| S7 | 10.416 | 3.0013 | 1.669547 | 55.43 | fourth lens L4 |
| S8 | −33.131 | 1.9079 | | | |
| S9 | 32.489 | 0.6400 | 1.808095 | 22.76 | fifth lens L5 |
| S10 | 7.362 | 3.3565 | 1.496999 | 81.54 | sixth lens L6 |
| S11 | −39.233 | 2.1952 | | | |
| S12 | −3730.351 | 1.8274 | 1.92286 | 18.90 | seventh lens L7 |
| S13 | −19.050 | 0.1000 | | | |
| S14 | 37.186 | 0.7000 | 1.739998 | 28.30 | eighth lens L8 |
| S15 | 8.616 | 0.2000 | | | |
| S16 | 6.187 | 2.3616 | 1.496999 | 81.54 | ninth lens L9 |
| S17 | 16.928 | d17 | 1.6779 | | |

| | F | Fno | FOV(2ω) | D5 | D6 | D17 |
|---|---|---|---|---|---|---|
| wide- | 3.99 | 1.3 | 167.5 | 8.5751 | 7.1093 | 5.7545 |
| angle end | | | | | | |
| telephoto | 9 | 2.2 | 55.5 | 1.8371 | 0.7777 | 12.0858 |
| end | | | | | | |

TABLE 4

| Surface | R (mm) | D (mm) | Nd | Vd | Component |
|---|---|---|---|---|---|
| S1 | 179.503 | 0.9266 | 1.6779 | 55.34 | first lens L1 |
| S2 | 7.054 | 5.6265 | | | |
| S3 | −19.470 | 0.6700 | 1.647689 | 33.79 | second lens L2 |
| S4 | 11.137 | 3.2039 | 1.92286 | 20.87 | third lens L3 |
| S5 | 181.825 | D5 | | | |
| S6 | infinity | D6 | | | aperture ST |
| S7 | 9.487 | 3.1553 | 1.669547 | 55.42 | fourth lens L4 |
| S8 | −26.986 | 1.5368 | | | |
| S9 | 89.305 | 0.6700 | 1.805181 | 25.42 | fifth lens L5 |
| S10 | 7.071 | 3.7665 | 1.496999 | 81.54 | sixth lens L6 |
| S11 | −21.252 | 1.5728 | | | |
| S12 | −26.267 | 1.6635 | 1.92286 | 18.89 | seventh lens L7 |
| S13 | −13.076 | 0.0700 | | | |
| S14 | 22.386 | 0.7300 | 1.6668 | 33.05 | eighth lens L8 |
| S15 | 7.484 | 0.1700 | | | |
| S16 | 5.708 | 2.4424 | 1.496999 | 81.54 | ninth lens L9 |
| S17 | 13.649 | D17 | | | |

| | F | Fno | FOV(2ω) | D5 | D6 | D17 |
|---|---|---|---|---|---|---|
| wide- | 3.99 | 1.3 | 167.4 | 8.5109 | 6.6171 | 5.9755 |
| angle end | | | | | | |
| telephoto | 9.05 | 2.1 | 55.5 | 1.3904 | 0.5809 | 12.0112 |
| end | | | | | | |

TABLE 5

| Surface | R (mm) | D (mm) | Nd | Vd | Component |
|---|---|---|---|---|---|
| S1 | 180.933 | 0.9370 | 1.6779 | 55.34 | first lens L1 |
| S2 | 6.899 | 5.5835 | | | |
| S3 | −19.077 | 0.7300 | 1.647689 | 33.79 | second lens L2 |
| S4 | 10.759 | 3.5020 | 1.92286 | 20.88 | third lens L3 |
| S5 | 135.945 | D5 | | | |
| S6 | infinity | D6 | | | aperture ST |
| S7 | 9.632 | 3.0906 | 1.669547 | 55.43 | fourth lens L4 |
| S8 | −44.283 | 1.4151 | | | |
| S9 | 24.121 | 0.7300 | 1.805181 | 25.43 | fifth lens L5 |
| S10 | 6.426 | 3.8940 | 1.496999 | 81.54 | sixth lens L6 |
| S11 | −33.565 | 1.8702 | | | |
| S12 | −23.973 | 1.5840 | 1.92286 | 18.90 | seventh lens L7 |
| S13 | −12.979 | 0.1300 | | | |
| S14 | 19.515 | 0.7300 | 1.850136 | 30.06 | eighth lens L8 |
| S15 | 8.619 | 0.1700 | | | |
| S16 | 5.842 | 2.3335 | 1.496999 | 81.54 | ninth lens L9 |
| S17 | 13.477 | D17 | | | |

| | F | Fno | FOV(2ω) | D5 | D6 | D17 |
|---|---|---|---|---|---|---|
| wide- | 3.99 | 1.3 | 167.7 | 7.7982 | 6.8425 | 6.0222 |
| angle end | | | | | | |
| telephoto | 8.98 | 2.2 | 55.5 | 1.6602 | 0.4499 | 12.4147 |
| end | | | | | | |

In addition, for each lens of the zoom lens 1-5 in the first to the fifth preferred embodiments, the surface concavity z of each of aspheric surfaces S7, S8, S16, and S17 is defined by the following formula:

$$z = \frac{{ch}^{2}}{1 + \sqrt{1 - ( 1 + k ) {c}^{2} {h}^{2}}} + {Ah}^{4} + {Bh}^{6} + {Ch}^{8} + {Dh}^{10} + {Eh}^{12} + {Fh}^{14} + {Gh}^{16} + {Hh}^{18} + {Jh}^{20}$$

where:
z is the surface sag;
c is the reciprocal of the radius of curvature;
h is the off-axis height of the surface;
k is conic constant; and
A-J respectively represents different order coefficient of h.

The conic constant k of each of aspheric surfaces S7, S8, S16 and S17, and each of order coefficients A-J of the zoom lenses 1-5 of the first to the fifth preferred embodiments of the present invention are respectively listed in the following Tables 6-10.

TABLE 6

| Surface | S7 | S8 | S16 | S17 |
|---|---|---|---|---|
| K | −0.138474 | −31.272872 | 0.234838 | 7.893315 |
| A | −0.544808E−04 | −0.880676E−04 | −0.503960E−03 | −0.478494E−04 |
| B | −0.215397E−05 | 0.454072E−05 | 0.924699E−04 | −0.232453E−04 |
| C | 0.646151E−06 | 0.141997E−05 | −0.319191E−04 | 0.839586E−05 |
| D | −0.875376E−07 | −0.408980E−06 | 0.547581E−05 | −0.127910E−05 |
| E | 0.761707E−08 | 0.491724E−07 | −0.574897E−06 | 0.820410E−07 |
| F | −0.417598E−09 | −0.316300E−08 | 0.370587E−07 | −0.108783E−08 |
| G | 0.134290E−10 | 0.113039E−09 | −0.143630E−08 | −0.132746E−09 |
| H | −0.226067E−12 | −0.211235E−11 | 0.305605E−10 | 0.641355E−11 |
| J | 0.151567E−14 | 0.160880E−13 | −0.274574E−12 | −0.866017E−13 |

TABLE 7

| Surface | S7 | S8 | S16 | S17 |
|---|---|---|---|---|
| K | −0.513642 | 8.016546 | 0.245354 | 13.390444 |
| A | 0.365372E−02 | 0.572497E−02 | −0.217232E−01 | −0.209672E−01 |
| B | −0.233783E−02 | −0.339488E−02 | 0.153173E−01 | 0.221801E−01 |
| C | 0.619799E−03 | 0.821513E−03 | −0.446234E−02 | −0.924364E−02 |
| D | −0.862037E−04 | −0.105136E−03 | 0.702758E−03 | 0.200316E−02 |
| E | 0.697377E−05 | 0.788006E−05 | −0.669465E−04 | −0.251754E−03 |
| F | −0.340360E−06 | −0.358354E−06 | 0.401634E−05 | 0.190487E−04 |
| G | 0.987865E−08 | 0.973878E−08 | −0.149904E−06 | −0.856074E−06 |
| H | −0.157029E−09 | −0.145567E−09 | 0.320136E−08 | 0.210562E−07 |
| J | 0.105265E−11 | 0.921010E−12 | −0.299817E−10 | −0.218344E−09 |

TABLE 8

| Surface | S7 | S8 | S16 | S17 |
|---|---|---|---|---|
| K | −0.287487 | −29.078113 | 0.370957 | 8.149836 |
| A | −0.444445E−03 | −0.366634E−03 | 0.419421E−02 | 0.812727E−04 |
| B | 0.325135E−03 | 0.207478E−03 | −0.421990E−02 | −0.118150E−02 |
| C | −0.942099E−04 | −0.651024E−04 | 0.149502E−02 | 0.569220E−03 |
| D | 0.142162E−04 | 0.105461E−04 | −0.278494E−03 | −0.105259E−03 |
| E | −0.123793E−05 | −0.981564E−06 | 0.302812E−04 | 0.821031E−05 |
| F | 0.646011E−07 | 0.545468E−07 | −0.199242E−05 | −0.106687E−06 |
| G | −0.199454E−08 | −0.178842E−08 | 0.781556E−07 | −0.223650E−07 |
| H | 0.335937E−10 | 0.319210E−10 | −0.168246E−08 | 0.128488E−08 |
| J | −0.237899E−12 | −0.239172E−12 | 0.152978E−10 | −0.214082E−10 |

TABLE 9

| Surface | S7 | S8 | S16 | S17 |
|---|---|---|---|---|
| K | −0.016397 | −34.866507 | 0.325964 | 7.658347 |
| A | −0.114093E−03 | −0.336838E−03 | 0.105756E−01 | 0.120654E−01 |
| B | 0.902375E−04 | 0.320840E−04 | −0.104470E−01 | −0.147985E−01 |
| C | −0.228627E−04 | −0.667017E−05 | 0.405628E−02 | 0.675924E−02 |
| D | 0.325163E−05 | 0.934997E−06 | −0.853281E−03 | −0.161385E−02 |
| E | −0.271810E−06 | −0.812856E−07 | 0.106701E−03 | 0.223687E−03 |
| F | 0.137956E−07 | 0.441521E−08 | −0.815310E−05 | −0.186555E−04 |
| G | −0.418121E−09 | −0.145788E−09 | 0.373055E−06 | 0.922817E−06 |
| H | 0.696318E−11 | 0.267907E−11 | −0.937844E−08 | −0.249376E−07 |
| J | −0.490148E−13 | −0.209725E−13 | 0.995151E−10 | 0.283539E−09 |

TABLE 10

| Surface | S7 | S8 | S16 | S17 |
|---|---|---|---|---|
| K | −0.057802 | −38.237948 | 0.381400 | 7.510150 |
| A | −0.108825E−02 | −0.925117E−03 | 0.504424E−02 | −0.255612E−01 |
| B | 0.773173E−03 | 0.687816E−03 | −0.778654E−02 | 0.245535E−01 |
| C | −0.206412E−03 | −0.195254E−03 | 0.374219E−02 | −0.967539E−02 |
| D | 0.289242E−04 | 0.292236E−04 | −0.886427E−03 | 0.206324E−02 |
| E | −0.236020E−05 | −0.255010E−05 | 0.117839E−03 | −0.263113E−03 |
| F | 0.116248E−06 | 0.134432E−06 | −0.923403E−05 | 0.206674E−04 |
| G | −0.340625E−08 | −0.421889E−08 | 0.423522E−06 | −0.980342E−06 |
| H | 0.546793E−10 | 0.725740E−10 | −0.105177E−07 | 0.257489E−07 |
| J | −0.370254E−12 | −0.526846E−12 | 0.109217E−09 | −0.287411E−09 |

In addition to the aforementioned optical specifications, in order to provide higher imaging quality, and to effectively achieve the purpose of reducing size and providing wide angle, the zoom lenses 1-5 can further satisfy the following conditions:

(1) −1.2<F/fl<−0.4;

(2) Vd>63;

(3) Vd6−Vd5>40;

(4) Vd9>63;

where F is the focal length of the zoom lenses 1-5; fl is the focal length of the first lens group G1; Vd5 is the Abbe number of the fifth lens L5; Vd6 is the Abbe number of the sixth lens L6; Vd9 is the Abbe number of the ninth lens L9.

If condition (1) is satisfied, the system size can be effectively reduced, and the aberration can be effectively suppressed as well. More specifically, if the zoom lenses 1-5 exceed the upper limit in condition (1), the refractive power of the first lens group G1 becomes too weak, which requires longer moving distance to perform the zooming operation, and therefore is not conducive to size reduction. On the contrary, if the zoom lenses 1-5 are less than the lower limit in condition (1), the refractive power of the first lens group G1 becomes too strong to effectively suppress the aberration.

In addition, if the zoom lenses 1-5 fail to satisfy conditions (2), (3), the axial chromatic aberration cannot be effectively suppressed, and the aberration from visible light to infrared light is worsened, which leads to poor image quality.

Furthermore, if the Abbe number of the ninth lens L9 is lower than the lower limit in condition (4), the chromatic aberration becomes worse. In other words, with the shape of the ninth lens L9 which satisfies condition (4), various kinds of aberration generated near the image plane can be effectively eliminated, and therefore the optical performance of the zoom lenses 1-5 can meet the optical requirements of an optical image sensor of megapixels.

The detailed parameters of the zoom lenses 1-5 of the first to the fifth preferred embodiments of the present invention are listed in Table 11:

TABLE 11

| | First Preferred | Second Preferred | Third Preferred | Fourth Preferred | Fifth Preferred |
|---|---|---|---|---|---|
| | Embodiment | Embodiment | Embodiment | Embodiment | Embodiment |
| F | 4.1(w)~9.2(t) | 4(w)~9(t) | 3.99(w)~9(t) | 3.99(w)~9.05(t) | 3.99(w)~8.98(t) |
| f1 | −8.54 | −8.25 | −8.64 | −8.88 | −8.51 |
| Vd5 | 22.76 | 23.77 | 22.76 | 25.42 | 25.43 |
| Vd6 | 81.54 | 81.54 | 81.54 | 81.54 | 81.54 |
| Vd9 | 81.54 | 81.54 | 81.54 | 81.54 | 81.54 |
| F/f1 | −0.48(w)~−1.08(t) | −0.48(w)~−1.099(t) | −0.46(w)~−1.04(t) | −0.45(w)~−1.02(t) | −0.47 (w)~−1.06(t) |
| Vd6 − Vd5 | 58.78 | 57.77 | 58.78 | 56.12 | 56.11 |

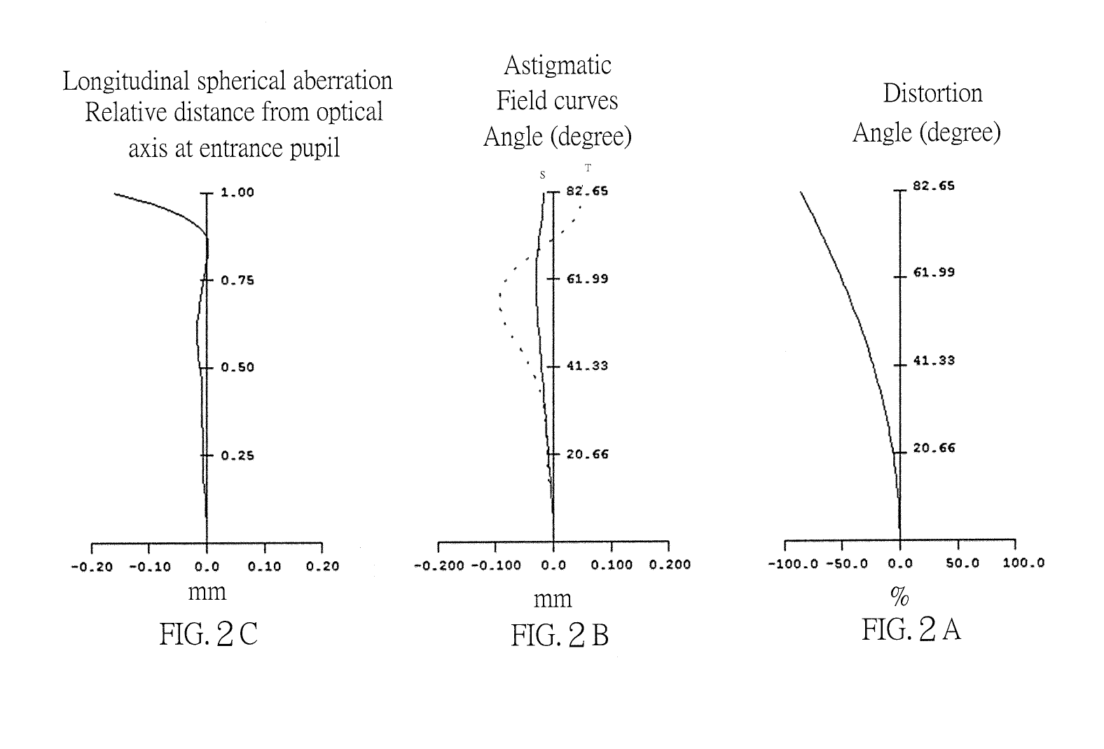

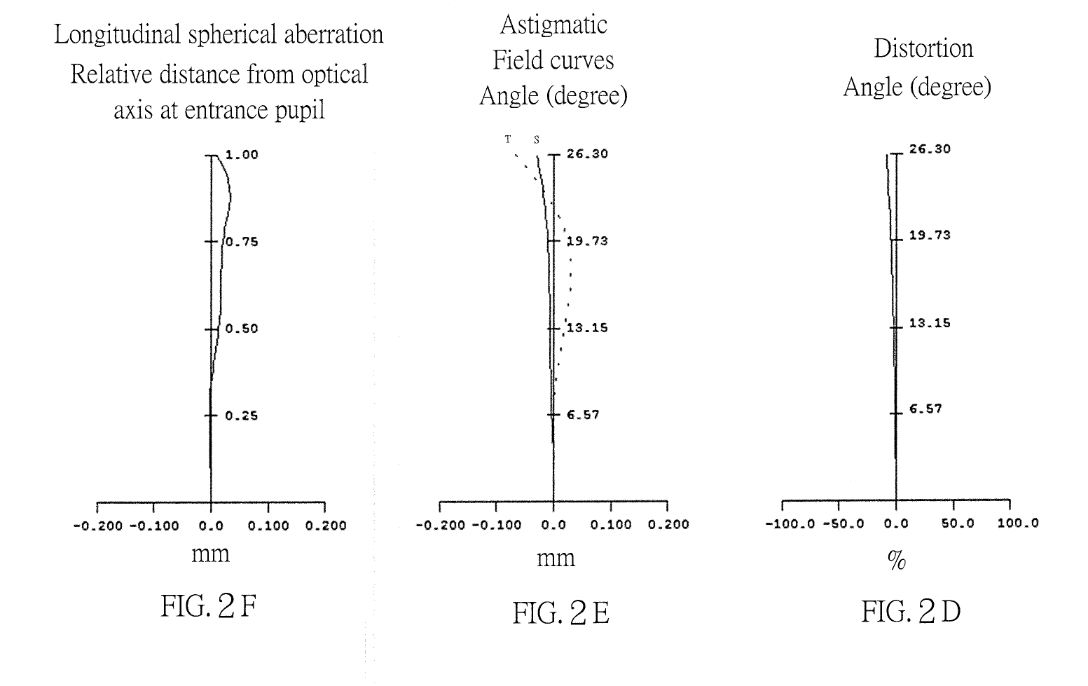

As shown in FIGS. 2A to 2C, the zoom lens 1 of the first preferred embodiment of the present invention is able to provide high imaging quality at the wide-angle end, wherein the maximum distortion of the zoom lens 1 does not exceed −100% and 0%, which can be seen in FIG. 2A; the maximum field curvature of the zoom lens 1 does not exceed -0.10 mm and 0.10 mm, which can be seen in FIG. 2B; the maximum longitudinal spherical aberration of the zoom lens 1 does not exceed −0.20 mm and 0.10 mm, which can be seen in FIG. 2C.

In addition, as shown in FIGS. 2D to 2F, the zoom lens 1 of the first preferred embodiment of the present invention is able to provide high imaging quality at the telephoto end, wherein the maximum distortion of the zoom lens 1 does not exceed −50% and 0%, which can be seen in FIG. 2D; the maximum field curvature of the zoom lens 1 does not exceed −0.10 mm and 0.10 mm, which can be seen in FIG. 2E; the maximum longitudinal spherical aberration of the zoom lens 1 does not exceed −0.10 mm and 0.10 mm, which can be seen in FIG. 2F.

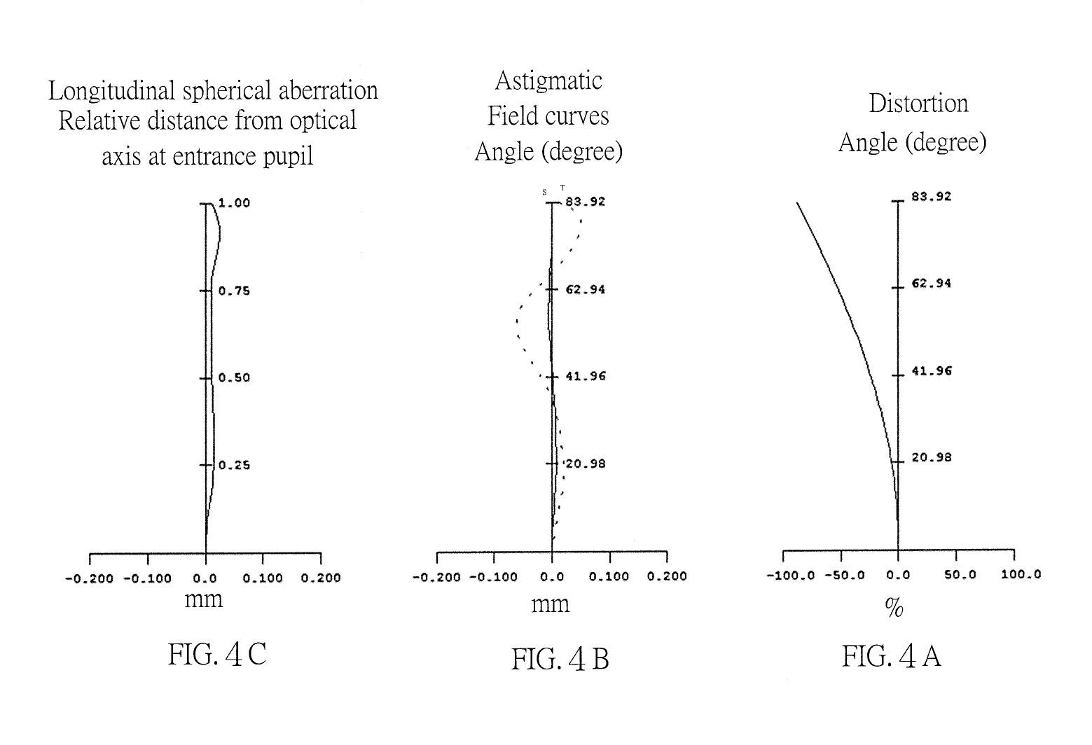

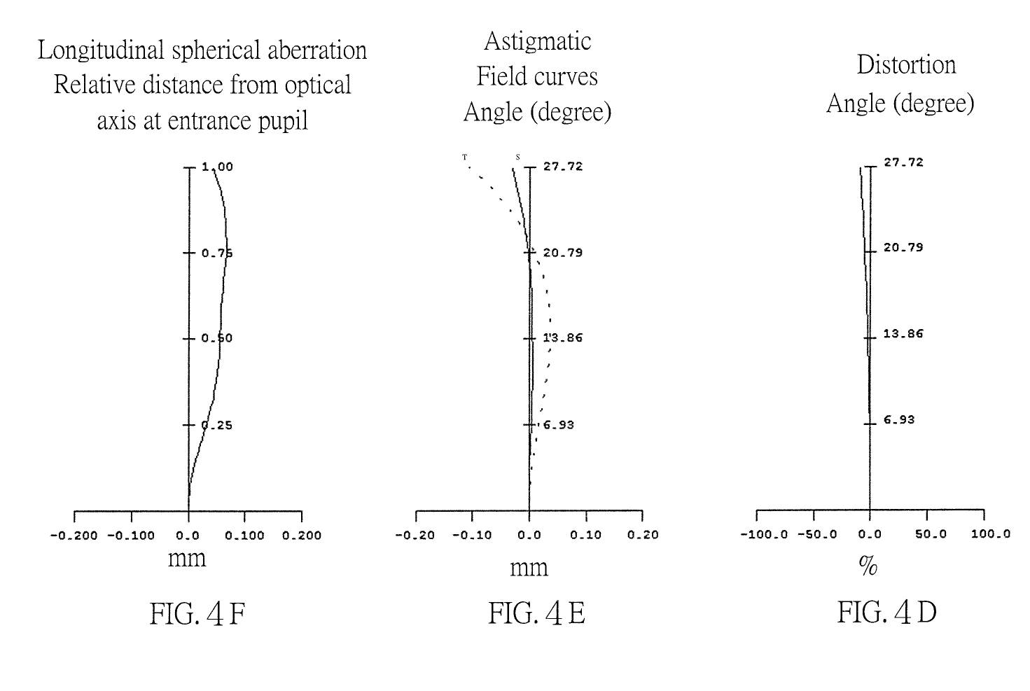

As shown in FIGS. 4A to 4C, the zoom lens 2 of the second preferred embodiment of the present invention is able to provide high imaging quality at the wide-angle end, wherein the maximum distortion of the zoom lens 2 does not exceed −100% and 0%, which can be seen in FIG. 4A; the maximum field curvature of the zoom lens 2 does not exceed −0.10 mm and 0.10 mm, which can be seen in FIG. 4B; the maximum longitudinal spherical aberration of the zoom lens 2 does not exceed −0.10 mm and 0.10 mm, which can be seen in FIG. 4C.

In addition, as shown in FIGS. 4D to 4F, the zoom lens 2 of the second preferred embodiment of the present invention is able to provide high imaging quality at the telephoto end, wherein the maximum distortion of the zoom lens 2 does not exceed −50% and 0%, which can be seen in FIG. 4D; the maximum field curvature of the zoom lens 2 does not exceed −0.20 mm and 0.10 mm, which can be seen in FIG. 4E; the maximum longitudinal spherical aberration of the zoom lens 2 does not exceed 0 mm and 0.10 mm, which can be seen in FIG. 4F.

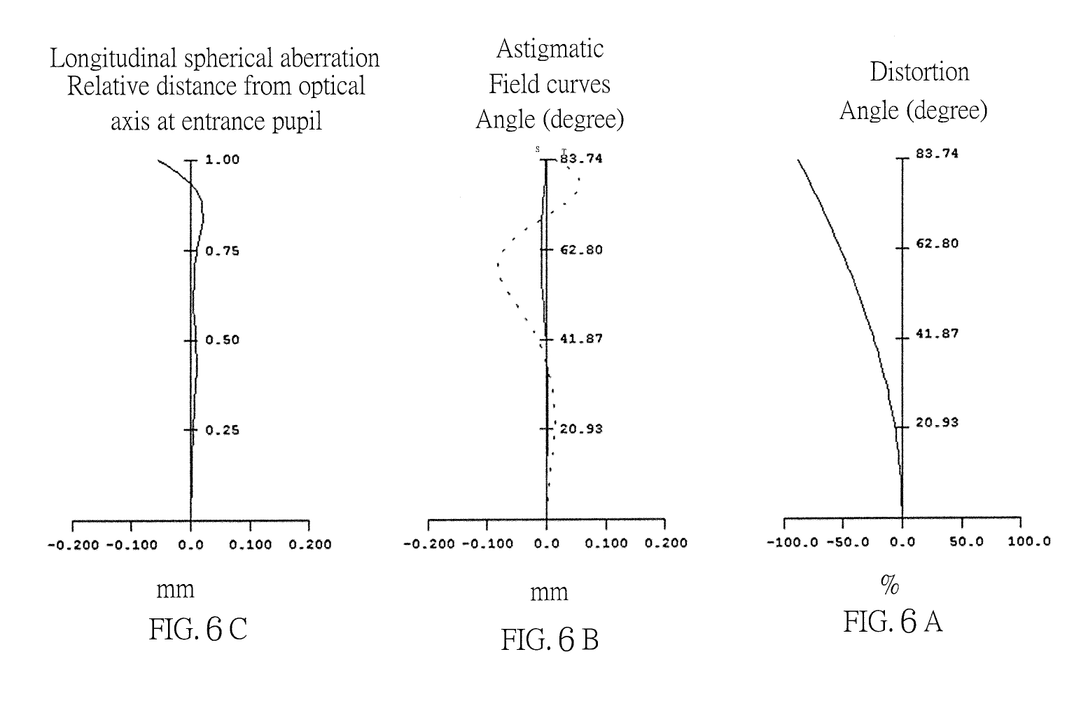

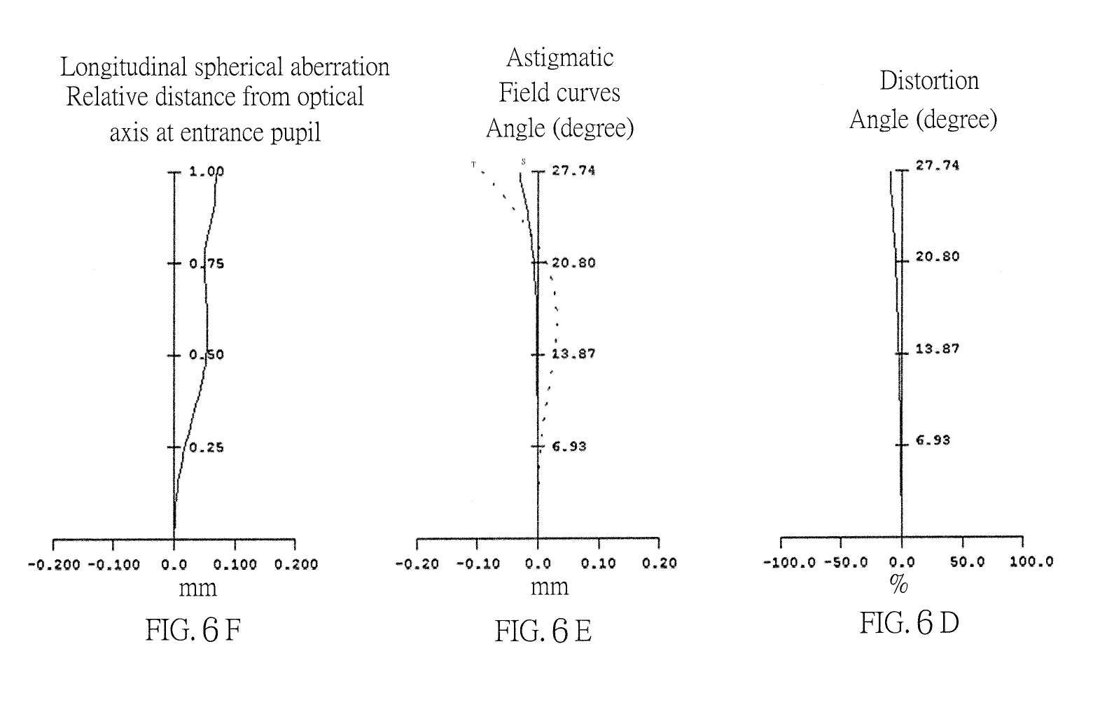

As shown in FIGS. 6A to 6C, the zoom lens 3 of the third preferred embodiment of the present invention is able to provide high imaging quality at the wide-angle end, wherein the maximum distortion of the zoom lens 3 does not exceed −100% and 0%, which can be seen in FIG. 6A; the maximum field curvature of the zoom lens 3 does not exceed −0.10 mm and 0.10 mm, which can be seen in FIG. 6B; the maximum longitudinal spherical aberration of the zoom lens 3 does not exceed −0.10 mm and 0.10 mm, which can be seen in FIG. 6C.

In addition, as shown in FIGS. 6D to 6F, the zoom lens 3 of the third preferred embodiment of the present invention is able to provide high imaging quality at the telephoto end, wherein the maximum distortion of the zoom lens 3 does not exceed −50% and 0%, which can be seen in FIG. 6D; the maximum field curvature of the zoom lens 3 does not exceed −0.10 mm and 0.10 mm, which can be seen in FIG. 6E; the maximum longitudinal spherical aberration of the zoom lens 3 does not exceed 0 mm and 0.10 mm, which can be seen in FIG. 6F.

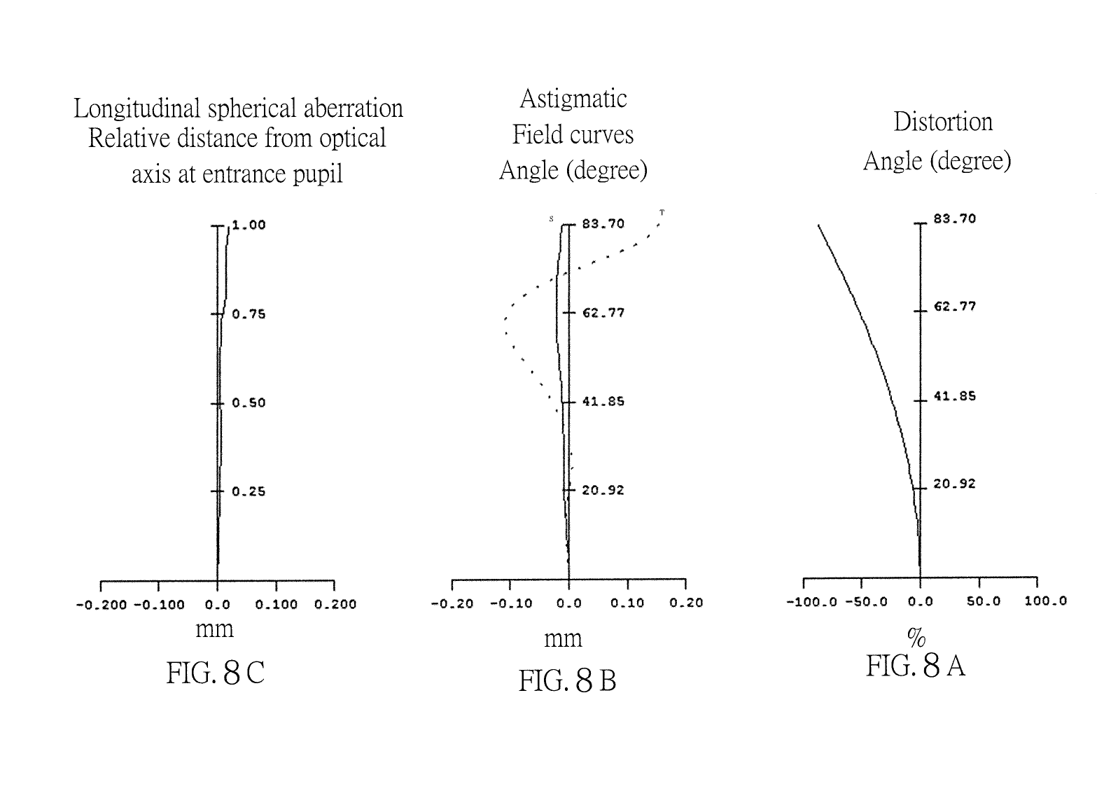

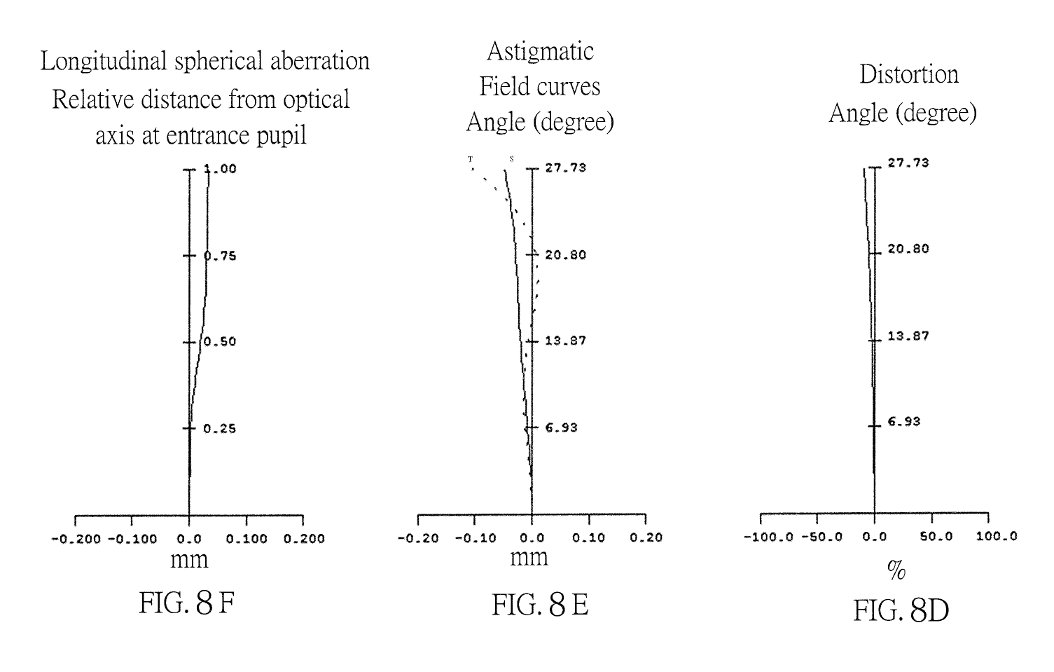

As shown in FIGS. 8A to 8C, the zoom lens 4 of the fourth preferred embodiment of the present invention is able to provide high imaging quality at the wide-angle end, wherein the maximum distortion of the zoom lens 4 does not exceed −100% and 0%, which can be seen in FIG. 8A; the maximum field curvature of the zoom lens 4 does not exceed −0.20 mm and 0.20 mm, which can be seen in FIG. 8B; the maximum longitudinal spherical aberration of the zoom lens 4 does not exceed 0 mm and 0.10 mm, which can be seen in FIG. 8C.

In addition, as shown in FIGS. 8D to 8F, the zoom lens 4 of the fourth preferred embodiment of the present invention is able to provide high imaging quality at the telephoto end, wherein the maximum distortion of the zoom lens 4 does not exceed −50% and 0%, which can be seen in FIG. 8D; the maximum field curvature of the zoom lens 4 does not exceed −0.20 mm and 0.10 mm, which can be seen in FIG. 8E; the maximum longitudinal spherical aberration of the zoom lens 4 does not exceed 0 mm and 0.10 mm, which can be seen in FIG. 8F.

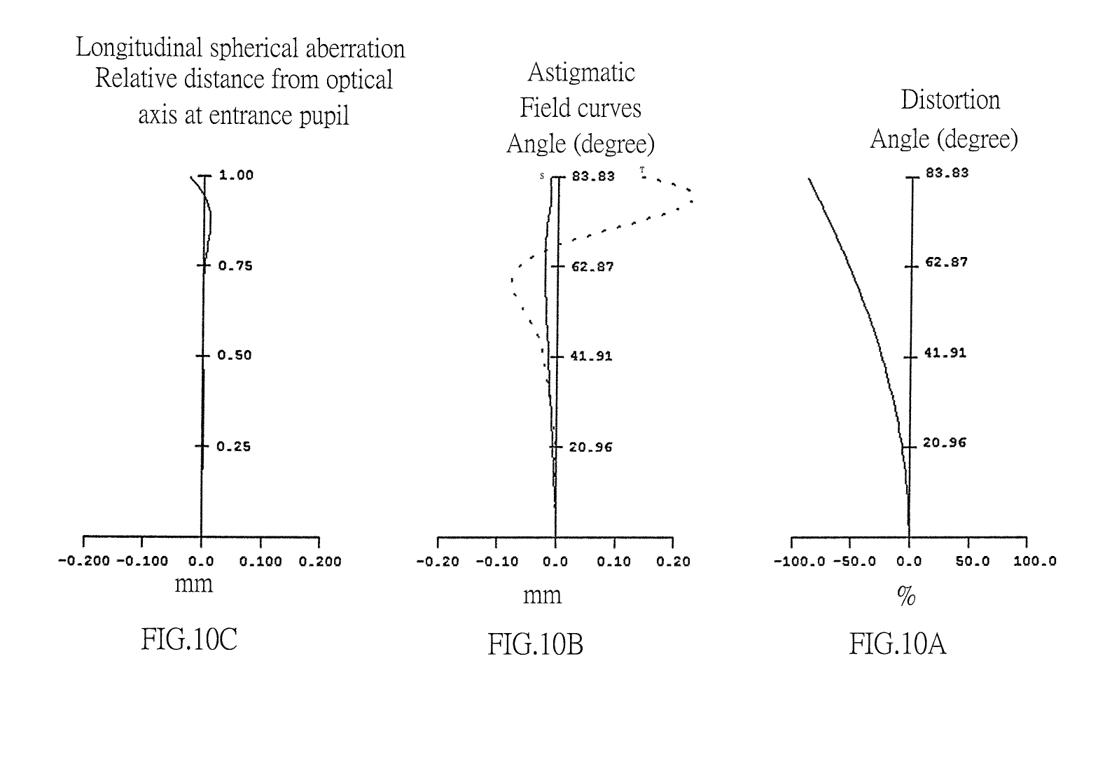

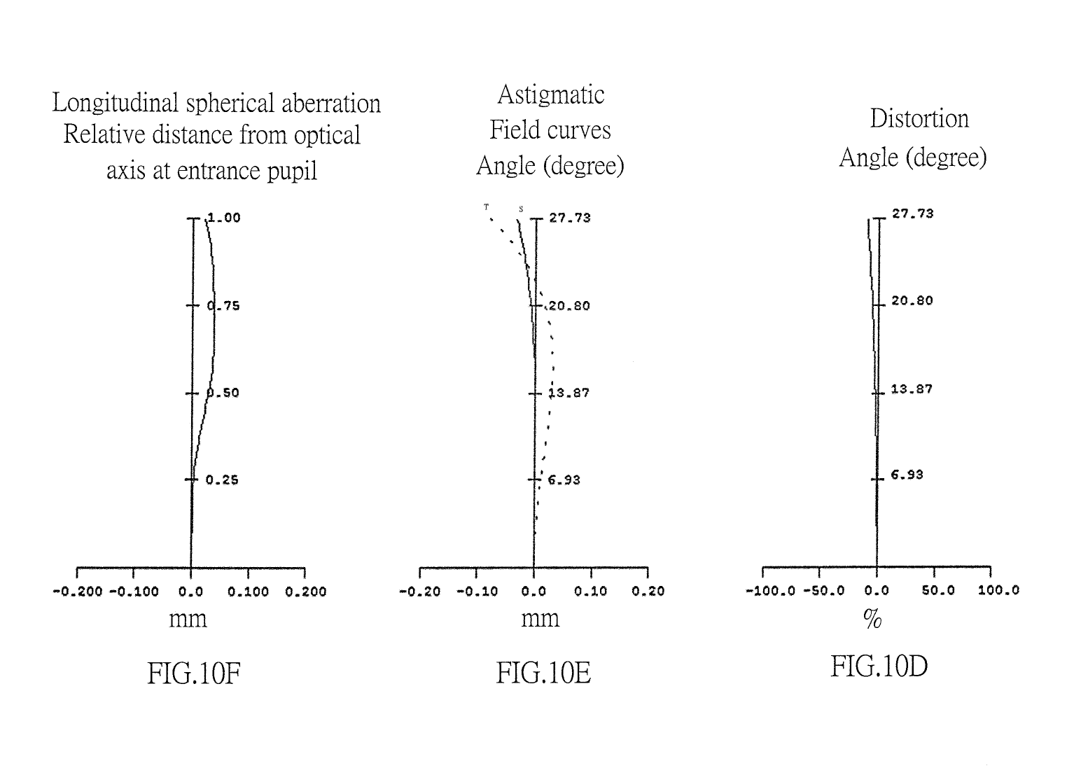

As shown in FIGS. 10A to 10C, the zoom lens 5 of the fifth preferred embodiment of the present invention is able to provide high imaging quality at the wide-angle end, wherein the maximum distortion of the zoom lens 5 does not exceed −100% and 0%, which can be seen in FIG. 10A; the maximum field curvature of the zoom lens 5 does not exceed −0.10 mm and 0.20 mm, which can be seen in FIG. 10B; the maximum longitudinal spherical aberration of the zoom lens 5 does not exceed −0.10 mm and 0.10 mm, which can be seen in FIG. 10C.

In addition, as shown in FIGS. 10D to 10F, the zoom lens 5 of the fifth preferred embodiment of the present invention is able to provide high imaging quality at the telephoto end, wherein the maximum distortion of the zoom lens 5 does not exceed −50% and 0%, which can be seen in FIG. 10D; the maximum field curvature of the zoom lens 5 does not exceed −0.10 mm and 0.10 mm, which can be seen in FIG. 10E; the maximum longitudinal spherical aberration of the zoom lens 5 does not exceed 0 mm and 0.10 mm, which can be seen in FIG. 10F.

In summary, with the aforementioned structure of the lenses, material of the lenses, and the optical conditions, the zoom lenses 1-5 provided in the present invention can provide the effect of large aperture from the wide-angle end to the telephoto end, and are compatible with a large image sensor of, for example, ½ inches. In addition, the size of the zoom lenses 1-5 can be still compact. Furthermore, the aberration from visible light to infrared light can be corrected by the zoom lenses 1-5, which also provide high resolution, and have the advantage of ease of manufacture and assembly.

It must be pointed out that the embodiments described above are only some preferred embodiments of the present invention. All equivalent structures which employ the concepts disclosed in this specification and the appended claims should fall within the scope of the present invention.

1. A zoom lens, in order from an object side to an image side along an optical axis, comprising:
a first lens group having negative refractive power, which is composed of a first lens, a second lens, and a third lens arranged sequentially from the object side to the image side, wherein the first lens has negative refractive power; the second lens has negative refractive power, the third lens has positive refractive power, and is adhered to the second lens to form a negative doublet, and wherein the first lens, the second lens, and the third lens are synchronously movable along the optical axis between the object side and an aperture;
the aperture; and
a second lens group having positive refractive power, which is composed of a fourth lens, a fifth lens, a sixth lens, a seventh lens, an eighth lens, and a ninth lens arranged sequentially from the object side to the image side, wherein the fourth lens has positive refractive power; the fifth lens has negative refractive power;power, the sixth lens has positive refractive power, and is adhered to the fifth lens to form a negative doublet, the seventh lens has positive refractive power, the eighth lens has negative refractive power, the ninth lens has positive refractive power, and wherein the fourth lens, the fifth lens, the sixth lens, the seventh lens, the eighth lens, and the ninth lens are synchronously movable along the optical axis between the aperture and the image side.

2. The zoom lens of claim 1, wherein: the first lens is a meniscus lens with a convex surface facing the object side, the second lens is a biconcave lens the third lens is a meniscus lens, a convex surface thereof facing the object side and adhered to a concave surface of the second lens which faces the image side.

3. The zoom lens of claim 1, wherein: the fourth lens is a biconvex lens, the fifth lens is a meniscus lens with a convex surface facing the object side, the sixth lens is a biconvex lens, a convex surface thereof facing the object side and adhered to a concave surface of the fifth lens which faces the image side, the seventh lens is a meniscus lens with a convex surface facing the image side, the eighth lens is a meniscus lens with a convex surface facing the object side, and the ninth lens is a meniscus lens with a convex surface facing the object side.

4. The zoom lens of claim 3, wherein the fourth lens has at least an aspheric surface.

5. The zoom lens of claim 4, wherein both surfaces of the fourth lens are aspheric.

6. The zoom lens of claim 3, wherein the ninth lens has at least an aspheric surface.

7. The zoom lens of claim 6, wherein both surfaces of the ninth lens are aspheric.

8. The zoom lens of claim 1, wherein the fifth lens and the sixth lens further satisfy the following conditions:
Vd6>63; and
Vd6−Vd5>40;
where Vd5 is an Abbe number of the fifth lens, and Vd6 is an Abbe number of the sixth lens.

9. The zoom lens of claim 1, wherein the ninth lens further satisfies the following condition:
Vd9>63;
where Vd9 is an Abbe number of the ninth lens.

10. The zoom lens of claim 1, further satisfying the following conditions:
−1.2<F/fl<−0.4;
where F is a focal length of the zoom lens, and fl is a focal length of the first lens group.
